(19) United States
(12) Patent Application Publication
(10) Pub. No.: US 2025/0067094 A1
(43) Pub. Date: Feb. 27, 2025

(54) Horse Stall Counterbalance Door Latch

(71) Applicant: SCUDDER Enterprises, Fort Worth, TX (US)

(72) Inventor: Curtis D. Gardner, Fort Worth, TX (US)

(73) Assignee: SCUDDER Enterprises, Fort Worth, TX (US)

(21) Appl. No.: 18/809,755

(22) Filed: Aug. 20, 2024

Related U.S. Application Data
(60) Provisional application No. 63/533,725, filed on Aug. 21, 2023.

(51) Int. Cl. E05C 3/04

(52) U.S. Cl. CPC E05C 3/047

(57) ABSTRACT

A counterbalance door latch having an axle arranged in a latch recess, the axle having an upper side and a lower side and a latch arranged on the axle, the latch having two positions, a recessed position in which the latch is fully recessed with no part protruding from the latch recess, and a latched position in which the latch is rotated around the axle so that a portion of the latch protrudes from the latch recess to prevent a door from sliding from a closed position.

### CROSS-REFERENCE TO RELATED APPLICATIONS

This application claims priority to provisional application No. 63/533,725, filed Aug. 21, 2023, and hereby incorporates the entire contents of this application by reference.

### FIELD OF THE INVENTION

The invention relates to a door latch and more specifically to a counterbalance door latch for a horse stall.

### BACKGROUND OF THE INVENTION

Animal stall doors which slide open and closed require a door latch to securely lock them in the closed position. Previous door latches can be opened by animals and/or are not safe, as the animals can scrap against them and be injured. What is needed is a door latch which can securely latch the door closed, but which is safe for the animals when the door is open.

### SUMMARY OF THE INVENTION

A counterbalance door latch having an axle arranged in a latch recess, the axle having an upper side and a lower side and a latch arranged on the axle, the latch having two positions, a recessed position in which the latch is fully recessed with no part protruding from the latch recess, and a latched position in which the latch is rotated around the axle so that a portion of the latch protrudes from the latch recess to prevent a door from sliding from a closed position.

The latch, when in the fully recessed position, has more of its weight arranged above the axle than below the axle. In one embodiment, about ⅔ of the latch weight is above the axle and ⅓ is below the axle.

The latch is moved from the fully recessed position to the latched position by pushing the lower portion of the latch towards a back of the latch recess until the upward portion of the latch falls forward under the force of gravity.

The upper portion of the latch is angled relative to the lower portion of the latch, to form a counterbalance latch wherein when in the fully recessed position the center of gravity of the latch is behind the axle and when in the latched position the center of gravity of the latch is in front of the axle.

### BRIEF DESCRIPTION OF DRAWINGS

FIG. 1 is a view showing the door stop which abuts the door when the door is slid to its fully closed position.

FIG. 2 is a front view of the door latch in a fully recessed position.

FIG. 3 is another view of the door latch in a fully recessed position.

FIG. 4 is a view of a person pushing on the lower portion of the door latch to move it from its fully recessed position to its latched position.

FIG. 5 is a view of the latch in its latched position.

FIG. 6 is a view of a person pushing on the upper portion of the door latch to move it from its latched position to its fully recessed position.

FIG. 7 is a front schematic view of the inventive counterbalance door latch, in the latched position.

FIG. 8 is a side view of FIG. 7.

FIG. 9 is a cross section view taken through A-A of FIG. 7.

FIG. 10 is a top view of FIG. 7.

FIG. 11 is a front schematic view of the inventive counterbalance door latch, in the latched position.

FIG. 12 is a side view of FIG. 11.

FIG. 13 is a cross section view taken through A-A of FIG. 11.

FIG. 14 is a top view of FIG. 11.

FIG. 15 is a front schematic view of the inventive counterbalance door latch, in the latched position.

FIG. 16 is a side view of FIG. 15.

FIG. 17 is a cross section view taken through A-A of FIG. 15.

FIG. 18 is a top view of FIG. 15.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

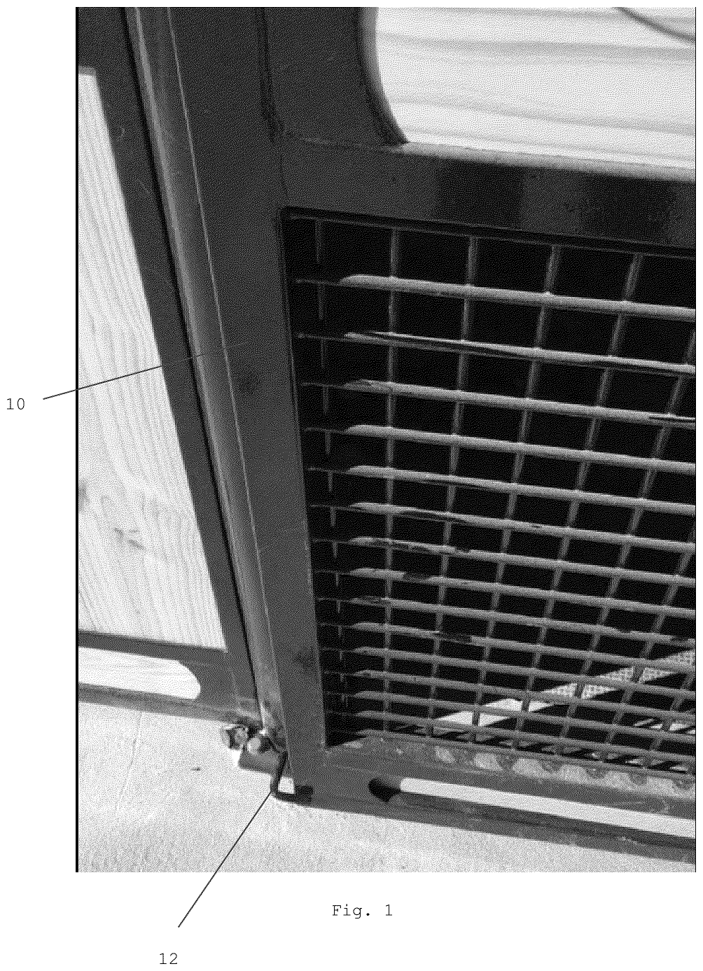

FIG. 1 is a view showing the door stop which abuts the door when the door is slid to its fully closed position, with the door shown at 10 and the door stop shown at 12.

FIG. 2 is a front view of the door latch in a fully recessed position, with a curved front plate shown at 14 and the latch shown generally at 16. The door latch 16 is shown in the fully recessed position, with no part of the door latch protruding past the front plate 14, which is safer for the animals when the door is open, as the animals cannot scrape themselves against the latch 16 when it is fully recessed.

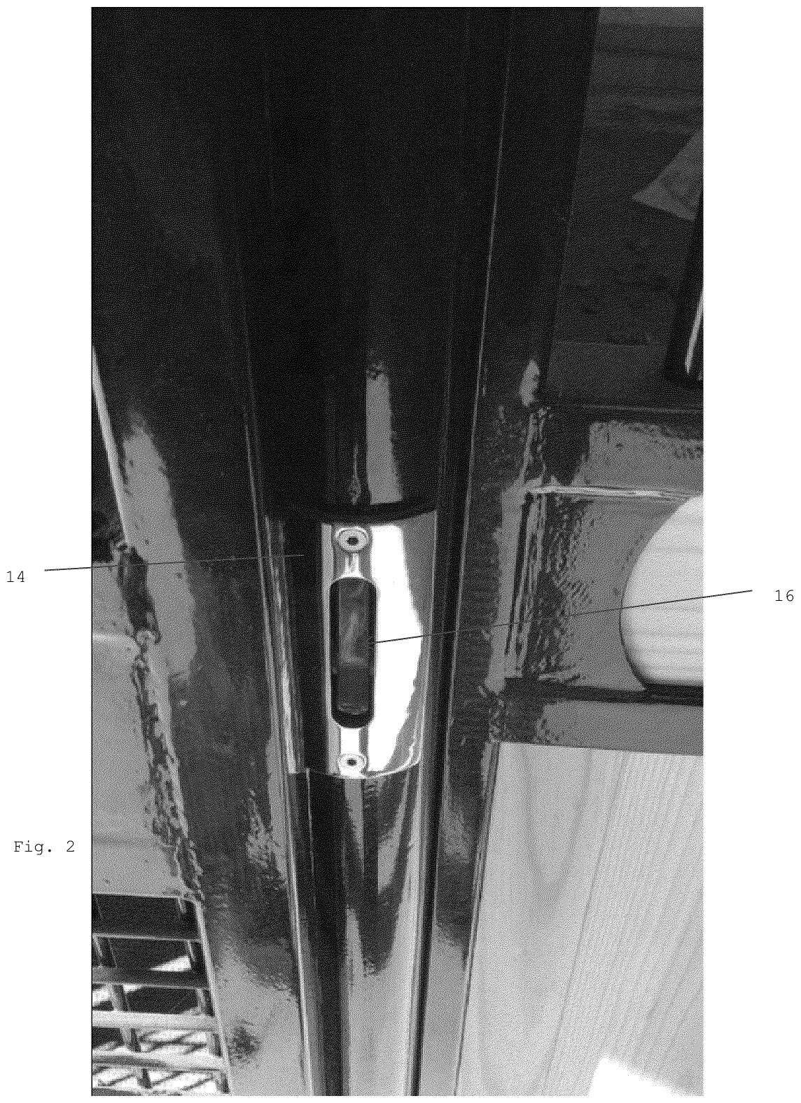

FIG. 3 is another view of the door latch in a fully recessed position. This view shows an axle 18 and that the latch has an upper portion 20 which is angled backwards relative to the lower portion 22, the angle starting at the axle 18 (better seen in later figures).

FIG. 4 is a view of a person pushing on the lower portion 22 of the door latch to move it from its fully recessed position to its latched position.

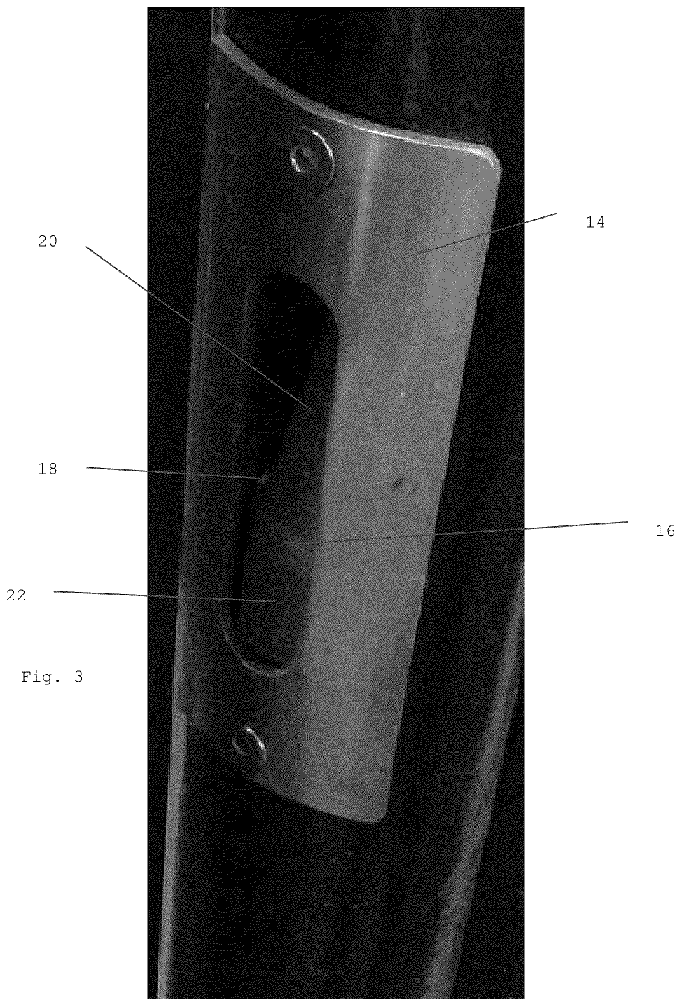

FIG. 5 is a view of the latch in its latched position, with the upper portion 20 rotated forward so the center of gravity of the latch 16 is forward of the axle and with the upper portion 20 blocking the door 10 from sliding open.

FIG. 6 is a view of a person pushing on the upper portion 20 of the door latch to move it from its latched position to its fully recessed position, which is when the upper portion 20 is pushed far enough so the center of gravity of the latch is behind the axle.

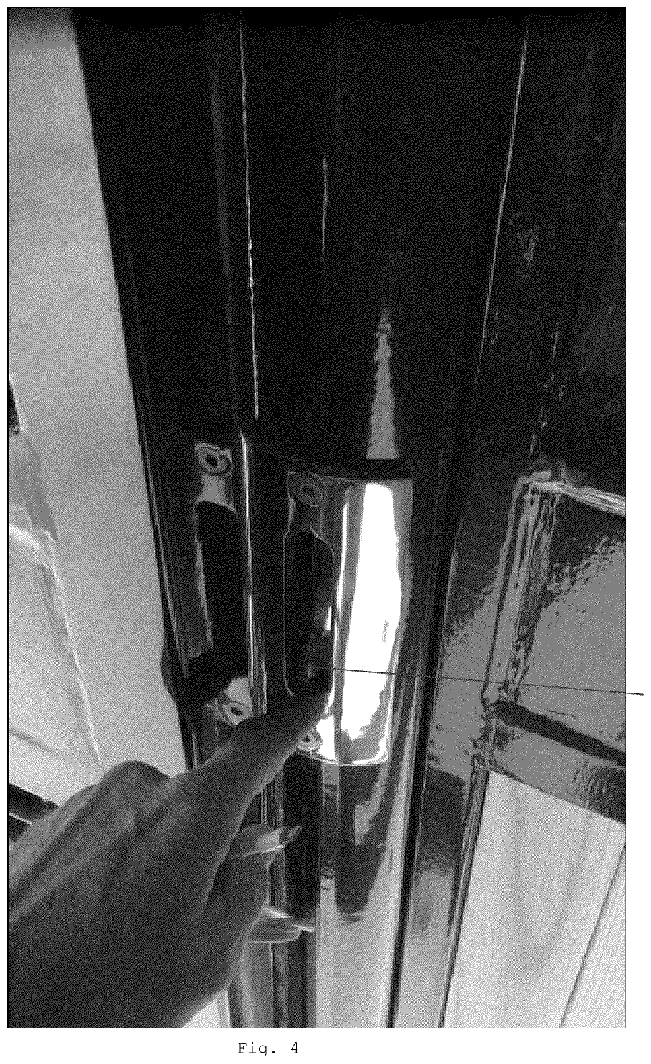

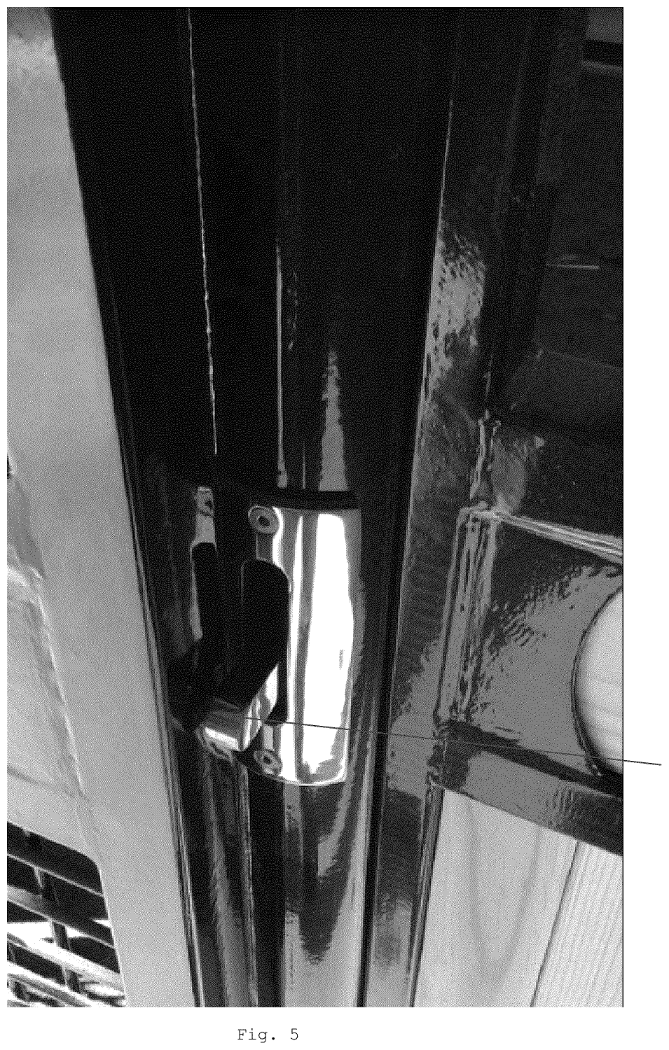

FIGS. 7-10 show schematic view of the inventive counterbalance door latch, in the latched position. The axle is shown at 18. The latch recess enclosure is shown at 24. The plate is shown at 14. The lower portion of latch 16 is shown at 22 and the upper portion is shown at 20. The angle between portions 20 and 22 is best seen in FIG. 9.

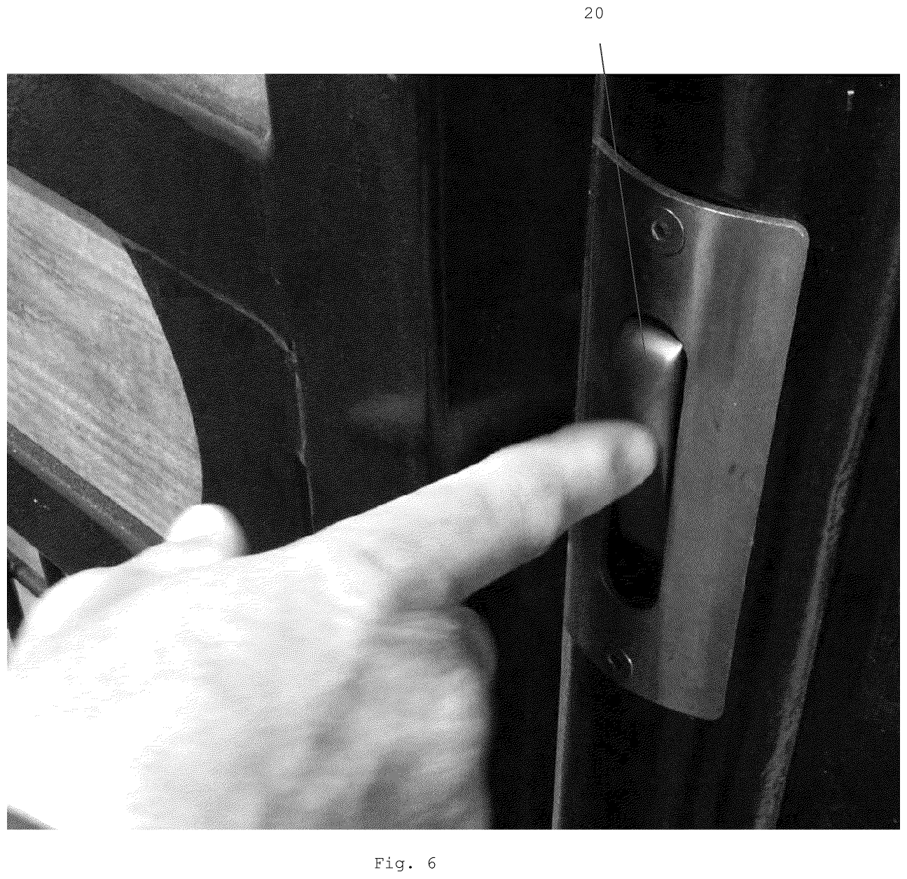

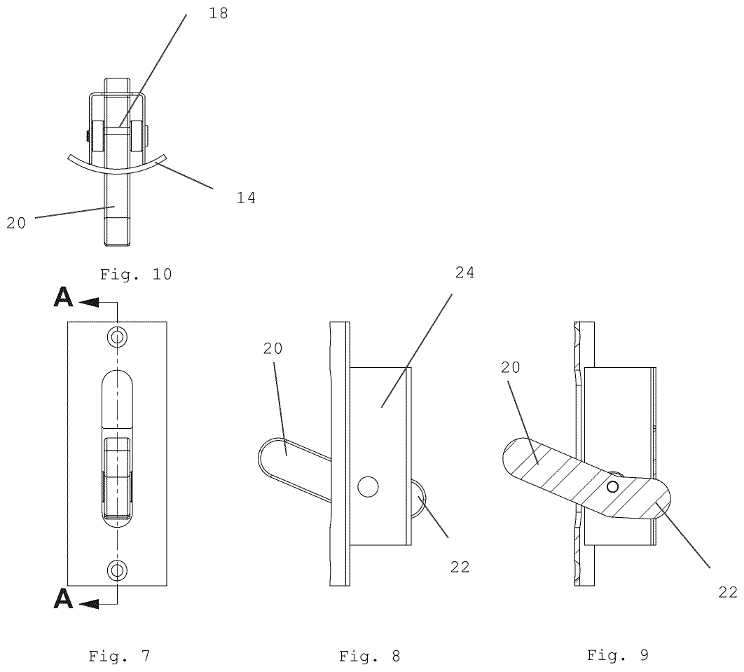

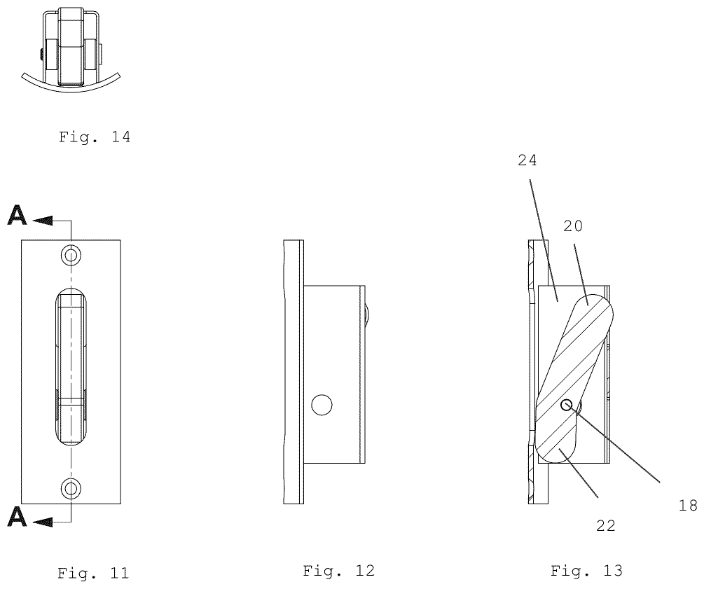

FIGS. 11-14 show schematic view of the inventive counterbalance door latch, in the fully recessed position. The axle is shown at 18. The latch recess enclosure is shown at 24. The lower portion of latch 16 is shown at 22 and the upper portion is shown at 20.

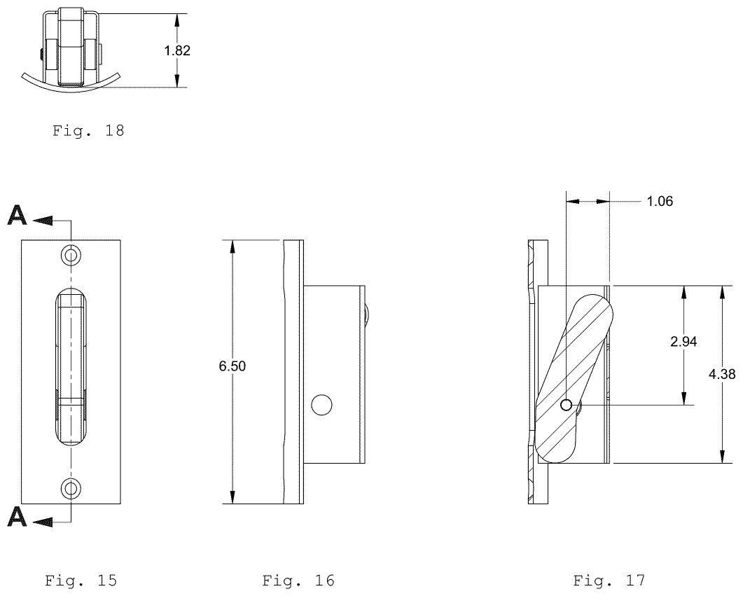

FIGS. 15-18 show the inventive counterbalance door latch, in the fully recessed position, with the dimensions of one embodiment.

1. A counterbalance door latch comprising:
an axle arranged in a latch recess, the axle having an upper side and a lower side;
a latch arranged on the axle, the latch having two positions, a recessed position in which the latch is fully recessed with no part protruding from the latch recess, and a latched position in which the latch is rotated around the axle so that a portion of the latch protrudes from the latch recess to prevent a door from sliding from a closed position.

2. The counterbalance door latch of claim 1 wherein the latch, when in the fully recessed position, has more of its weight arranged above the axle than below the axle.

3. The counterbalance door latch of claim 2 wherein about ⅔ of the latch weight is above the axle and ⅓ is below the axle.

4. The counterbalance door latch of claim 3 wherein the latch is moved from the fully recessed position to the latched position by pushing the lower portion of the latch towards a back of the latch recess until the upward portion of the latch falls forward under the force of gravity.

5. The counterbalance door latch of claim 1 wherein the upper portion of the latch is angled relative to the lower portion of the latch, to form a counterbalance latch wherein when in the fully recessed position the center of gravity of the latch is behind the axle and when in the latched position the center of gravity of the latch is in front of the axle.
